(19) United States
(12) Patent Application Publication
(10) Pub. No.: US 2022/0056670 A1
(43) Pub. Date: Feb. 24, 2022

(54) TRANSPORT VEHICLE MANAGEMENT SYSTEM AND TRANSPORT VEHICLE MANAGEMENT METHOD

(71) Applicants: Komatsu Ltd., Tokyo (JP); National University Corporation YOKOHAMA National University, Yokohama-shi (JP)

(72) Inventors: Takashi Maekawa, Yokohama-shi (JP); Riku Usami, Yokohama-shi (JP); Yuji Kobashi, Tokyo (JP)

(73) Assignees: Komatsu Ltd., Tokyo (JP); National University Corporation YOKOHAMA National University, Yokohama-shi (JP)

(21) Appl. No.: 17/312,516

(22) PCT Filed: Dec. 12, 2019
(86) PCT No.: PCT/JP2019/048815

§ 371 Date: Jun. 10, 2021

(30) Foreign Application Priority Data
Dec. 14, 2018 (JP) 2018-234749

(51) Int. Cl. E02F 9/20; G05D 1/02

(52) U.S. Cl. CPC E02F 9/2045; E02F 9/205; G05D 2201/021; G05D 1/0274; G05D 1/0223

(57) ABSTRACT

A transport vehicle management system includes: a three-dimensional data acquisition unit that acquires three-dimensional data of a work site; a two-dimensional course generation unit that generates a two-dimensional course for a transport vehicle on a two-dimensional plane set at the work site; and a three-dimensional course generation unit that generates a three-dimensional course of the transport vehicle from the two-dimensional course, based on the three-dimensional data.

### FIELD

The present disclosure relates to a transport vehicle management system and a transport vehicle management method.

### BACKGROUND

Unmanned transport vehicles are used for transport works in large-scale work sites such as mines. In a work site, a course on which the transport vehicle travels is set. The transport vehicle is controlled to travel according to the course.

### CITATION LIST

### Patent Literature

Patent Literature 1: 2017-049172 A

### SUMMARY

### Technical Problem

With a capability of setting the course in consideration of the terrain of the work site, the transport vehicle can be driven to travel at an appropriate travel speed. Allowing the transport vehicle to travel at an appropriate travel speed would make it possible to suppress the deterioration in productivity at the work site.

An aspect of the present invention is to suppress the deterioration in productivity at a work site.

### Solution to Problem

According to an aspect of the present invention, a transport vehicle management system comprises: a three-dimensional data acquisition unit that acquires three-dimensional data of a work site; a two-dimensional course generation unit that generates a two-dimensional course for a transport vehicle on a two-dimensional plane set at the work site; and a three-dimensional course generation unit that generates a three-dimensional course of the transport vehicle from the two-dimensional course, based on the three-dimensional data.

### Advantageous Effects of Invention

According to the aspect of the present invention, it is possible to suppress the deterioration in productivity at a work site.

### BRIEF DESCRIPTION OF DRAWINGS

FIG. 1 is a view schematically illustrating an example of a transport vehicle management system and a work site where the transport vehicle operates according to an embodiment.

FIG. 2 is a perspective rear view of the transport vehicle according to the embodiment.

FIG. 3 is a functional block diagram illustrating an example of a management device according to the embodiment.

FIG. 4 is a schematic view illustrating the processes performed by a two-dimensional course generation unit according to the embodiment.

FIG. 5 is a schematic view illustrating the processes performed by a three-dimensional curved surface generation unit according to the embodiment.

FIG. 6 is a schematic view illustrating the processes performed by a three-dimensional course generation unit according to the embodiment.

FIG. 7 is a schematic diagram illustrating the processes performed by a course judgment unit according to the embodiment.

FIG. 8 is a schematic diagram illustrating the processes performed by a two-dimensional course correction unit according to the embodiment.

FIG. 9 is a schematic diagram illustrating the processes performed by a travel speed determination unit according to the embodiment.

FIG. 10 is a schematic view illustrating the processes performed by the travel speed determination unit according to the embodiment.

FIG. 11 is a functional block diagram illustrating an example of a travel control device according to the embodiment.

FIG. 12 is a flowchart illustrating an example of a management method for the transport vehicle according to the embodiment.

FIG. 13 is a schematic view illustrating the processes performed by a three-dimensional course generation unit according to an embodiment.

FIG. 14 is a schematic view illustrating the processes performed by a three-dimensional course generation unit according to an embodiment.

FIG. 15 is a block diagram illustrating an example of a computer system according to an embodiment.

### DESCRIPTION OF EMBODIMENTS

Hereinafter, embodiments according to the present disclosure will be described with reference to the drawings, but the present disclosure is not limited to the embodiments. The constituents described in the embodiments below can be appropriately combine with each other. In some cases, a portion of the constituents is not utilized.

[Work Site]

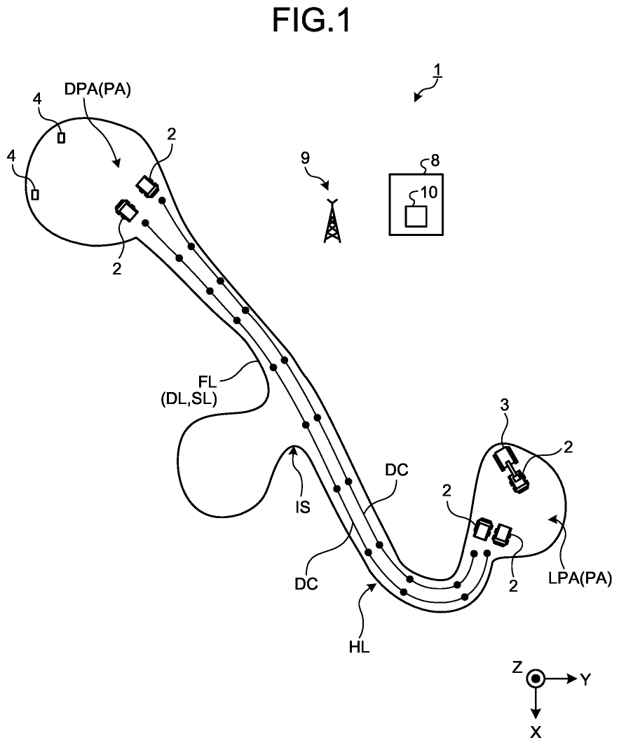

FIG. 1 is a view schematically illustrating an example of a management system 1 of a transport vehicle 2 and a work site in which the transport vehicle 2 is operating according to an embodiment. In the embodiment, the work site is a mine. The transport vehicle 2 is a dump truck capable of transporting cargo while traveling on a work site. A mine is a place where minerals are mined or an office concerning the mining. Examples of the cargo carried on the transport vehicle 2 include ore, or earth and sand, excavated in a mine. The work site may be a quarry.

The transport vehicle 2 travels at least in a part of a work place PA of a mine and in a travel path HL leading to the work place PA. The work place PA includes at least one of a loading area LPA or a dumping area DPA. The travel path HL includes an intersection IS.

The loading area LPA refers to an area in which a loading work of loading the transport vehicle 2 with cargo is conducted. At the loading area LPA, a loading machine 3 such as an excavator operates. The dumping area DPA is an area in which a dumping operation of dumping the cargo from the transport vehicle 2 is conducted. For example, a crusher 4 is disposed in the dumping area DPA.

The management system 1 includes a management device 10 and a communication system 9. The management device 10 includes a computer system and is installed in an administration facility 8 in a mine, for example. The management device 10 outputs a control command for controlling the transport vehicle 2. The communication system 9 performs communication between the management device 10 and the transport vehicle 2. The management device 10 and the transport vehicle 2 wirelessly communicate with each other via the communication system 9.

The transport vehicle 2 refers to an unmanned dump truck that performs unmanned travel without using operation by a driver. The transport vehicle 2 travels following a three-dimensional course DC set in the travel path HL and the work place PA based on a control command output from the management device 10. The transport vehicle 2 travels from the loading area LPA to the dumping area DPA or from the dumping area DPA to the loading area LPA according to the three-dimensional course DC. The three-dimensional course DC includes a target travel route of the transport vehicle 2 set at the work site.

The absolute position of the transport vehicle 2 is detected using a global navigation satellite system (GNSS). The global navigation satellite systems include a global positioning system (GPS). The global navigation satellite system detects the absolute position of the transport vehicle 2 defined by coordinate data of latitude, longitude, and altitude. The global navigation satellite system detects the absolute position of the transport vehicle 2 as defined in a global coordinate system. The global coordinate system is a coordinate system fixed to the earth.

A local coordinate system is set at the work site. The local coordinate system is a coordinate system based on an origin and coordinate axes set at the work site. In the embodiment, the local coordinate system is defined by the XYZ Cartesian coordinate system. The coordinate axes of the local coordinate system include an X-axis, a Y-axis orthogonal to the X-axis, and a Z-axis orthogonal to both the X-axis and the Y-axis. A two-dimensional plane set at the work site is an XY plane including the X-axis and the Y-axis. A three-dimensional space set in the work site is an XYZ space including the X-axis, the Y-axis, and the Z-axis. The Y-axis is orthogonal to the X-axis in the XY plane. The Z-axis is orthogonal to the XY plane. The position in the XY plane is defined by the X coordinate and the Y coordinate. The position in XYZ space is defined by the X coordinate, the Y coordinate, and the Z coordinate. The position in the global coordinate system and the position in the local coordinate system can be converted with each other using conversion parameters.

[Transport Vehicle]

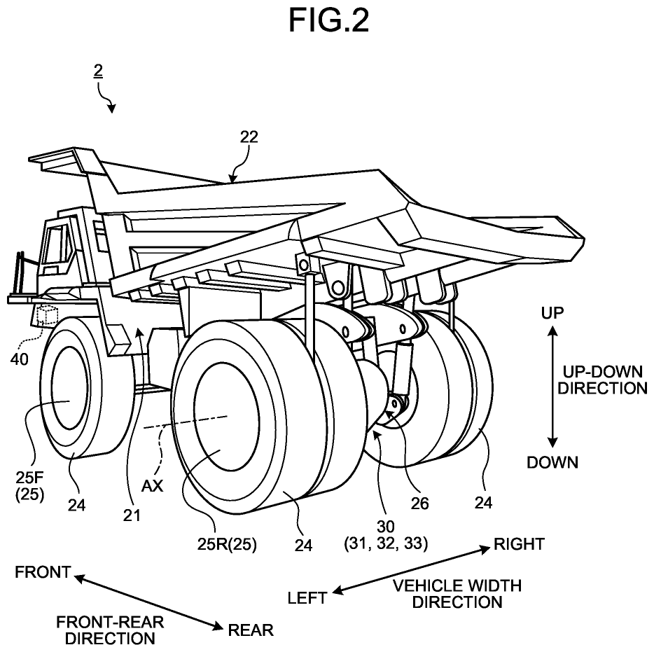

FIG. 2 is a perspective rear view of the transport vehicle 2 according to the embodiment. As illustrated in FIG. 2, the transport vehicle 2 includes a vehicle body frame 21, a dump body 22 supported by the vehicle body frame 21, a traveling device 30 that travels while supporting the vehicle body frame 21, and a travel control device 40 that controls the traveling device 30.

The traveling device 30 has wheels 25 on which tires 24 are mounted. The wheels 25 include front wheels 25F and rear wheels 25R. Furthermore, the traveling device 30 includes: a driving device 31 that generates a driving force that rotates the rear wheels 25R; a braking device 32 that generates a braking force that stops the rotation of the wheels 25; and a steering device 33 that steers the front wheels 25F. The rear wheels 25R are not steered. The wheel 25 rotates about a rotation axis AX.

In the following description, the direction parallel to the rotation axis AX of the rear wheels 25R is appropriately referred to as a vehicle width direction, the traveling direction of the transport vehicle 2 is appropriately referred to as a front-rear direction, and the direction orthogonal to the vehicle width direction and the front-rear direction individually is appropriately referred to as an up-down direction.

One direction in the front-rear direction is front and the other direction is rear. One direction in the vehicle width direction is right and the other is left. One direction in the up-down direction is up and the other is down. The front wheels 25F are located in front of the rear wheels 25R. The front wheels 25F are arranged on both sides in the vehicle width direction. The rear wheels 25R are arranged on both sides in the vehicle width direction. The dump body 22 is located above the vehicle body frame 21.

The vehicle body frame 21 supports the traveling device 30. The dump body 22 is a member on which cargo is loaded.

The traveling device 30 includes a rear axle 26 that transmits the driving force generated by the driving device 31 to the rear wheels 25R. The rear axle 26 includes an axle that supports the rear wheels 25R. The rear axle 26 transmits the driving force generated by the driving device 31 to the rear wheels 25R. The rear wheel 25R rotates about the rotation axis AX by the driving force supplied from the rear axle 26. This allows the traveling device 30 to travel.

The travel control device 40 includes a computer system and is mounted on the transport vehicle 2. The travel control device 40 can control the traveling device 30 of the transport vehicle 2 based on the control command transmitted from the management device 10.

[Management Device]

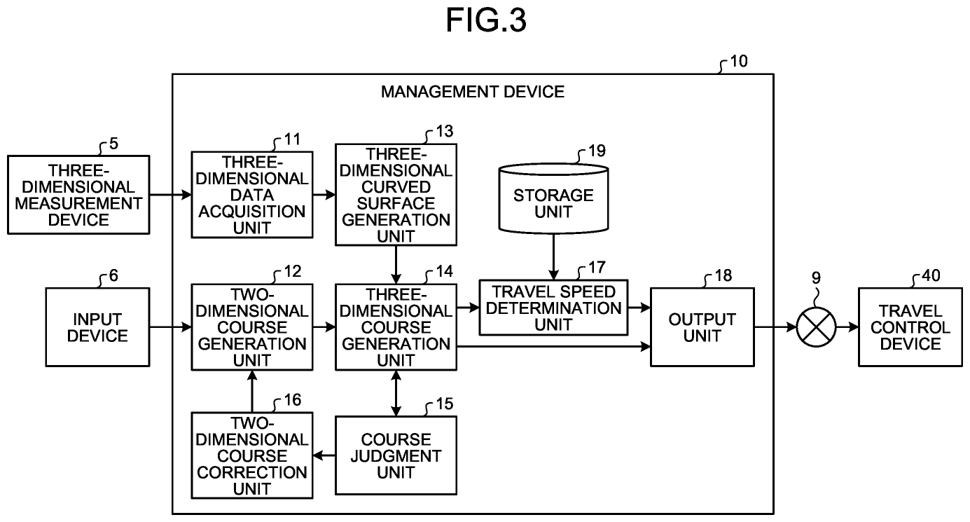

FIG. 3 is a functional block diagram illustrating an example of the management device 10 according to the embodiment. The management device 10 wirelessly communicates with the travel control device 40 of the transport vehicle 2 via the communication system 9.

The management device 10 includes a three-dimensional data acquisition unit 11, a two-dimensional course generation unit 12, a three-dimensional curved surface generation unit 13, a three-dimensional course generation unit 14, a course judgment unit 15, a two-dimensional course correction unit 16, a travel speed determination unit 17, an output unit 18, and a storage unit 19.

The three-dimensional data acquisition unit 11 acquires three-dimensional data of a work site. The three-dimensional data of the work site represents three-dimensional shapes of the terrain of the work site. The three-dimensional data acquisition unit 11 is connected to a three-dimensional measurement device 5. The three-dimensional measurement device 5 can acquire the three-dimensional data of the work site. Examples of the three-dimensional measurement device 5 include a stereo camera or a laser range finder mounted on an unmanned aerial vehicle (UAV) such as a drone. The unmanned aerial vehicle flies over the work site and measures the terrain of the work site using the three-dimensional measurement device 5. The measurement data of the three-dimensional measurement device 5 includes the three-dimensional data of the work site. The three-dimensional data of the work site measured by the three-dimensional measurement device 5 is output to the three-dimensional data acquisition unit 11. The three-dimensional data acquisition unit 11 acquires three-dimensional data of the work site from the three-dimensional measurement device 5.

The three-dimensional measurement device 5 may be a stereo camera or a laser range finder installed at a work site, for example. The three-dimensional measurement device 5 may be a monocular camera, a laser sensor, or a radar sensor. The three-dimensional measurement device 5 may be mounted on the transport vehicle 2.

The three-dimensional data acquired by the three-dimensional data acquisition unit 11 includes point cloud data representing three-dimensional shapes of the terrain of the work site. The point cloud data is an aggregate of a plurality of measurement points MP measured by the three-dimensional measurement device 5 on the surface of the terrain at the work site. The position of each of the plurality of measurement points MP is defined by the X coordinate, the Y coordinate, and the Z coordinate.

The two-dimensional course generation unit 12 generates a two-dimensional course UC for the transport vehicle 2 on a two-dimensional plane set at the work site. The two-dimensional course UC refers to a target travel route for the transport vehicle 2 set on the two-dimensional plane. The two-dimensional plane includes the XY plane. The two-dimensional course UC is two-dimensional data of the target travel route.

The two-dimensional course generation unit 12 is connected to an input device 6. Examples of the input device 6 include at least one of a keyboard, a mouse, or a touch panel for a computer. The input data generated by operating the input device 6 is output to the two-dimensional course generation unit 12. By operating the input device 6, at least a part of the input data required for generating the two-dimensional course UC is input to the two-dimensional course generation unit 12. In the present embodiment, by operating the input device 6, for example, a departure point and a destination point of the two-dimensional course UC are input as input data.

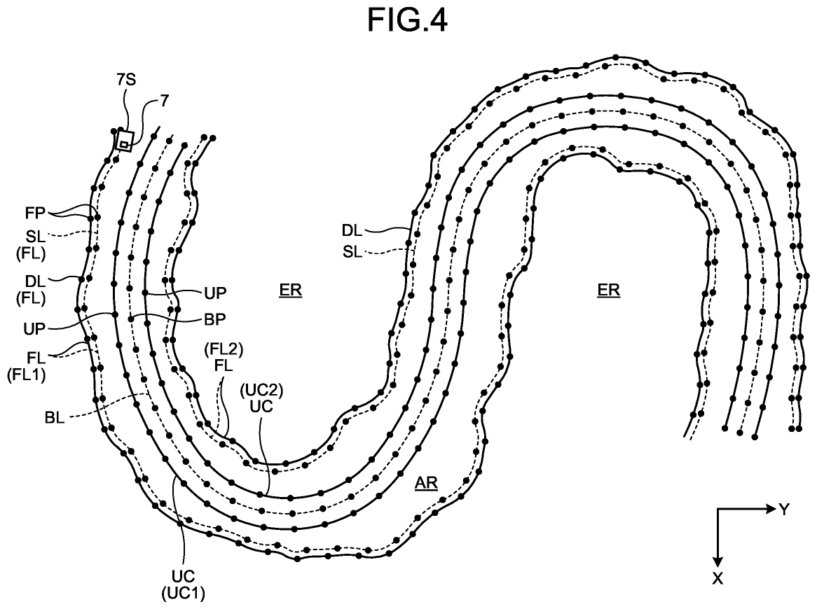

FIG. 4 is a schematic view illustrating the processes performed by the two-dimensional course generation unit 12 according to the embodiment. At the work site, a traveling area AR in which the transport vehicle 2 can travel and a prohibited area ER in which the transport vehicle 2 cannot travel are set. The traveling area AR is an area in which the transport vehicle 2 is permitted to travel. The prohibited area ER is an area in which the transport vehicle 2 is prohibited from traveling. The traveling area AR and the prohibited area ER are defined on a two-dimensional plane (XY plane) set at the work site. The traveling area AR and the prohibited area ER may be defined in a three-dimensional space set at the work site.

The traveling area AR includes the travel path HL and the work place PA. FIG. 4 illustrates the traveling area AR of the travel path HL. The two-dimensional course UC is set in the traveling area AR.

The traveling area AR is defined by an outline FL of the traveling area AR. The outline FL is a dividing line that divides between the traveling area AR and the prohibited area ER. The traveling area AR is an area on one side of the outline FL, while the prohibited area ER is an area on the other side of the outline FL.

Examples of the outline FL include at least one of a boundary line DL of the terrain of the work site, or a survey line SL set based on a traveling locus of a survey vehicle 7 traveling along the boundary line DL. That is, the outline FL may be defined either by the boundary line DL of the terrain or by the survey line SL.

The boundary line DL of the terrain is a characteristic portion usable to divide a work site, such as a bank or a cliff. The boundary line DL may be a portion that divides between the traveling area AR in which the transport vehicle 2 is permitted to travel and the prohibited area ER in which the transport vehicle 2 is not permitted to travel. The boundary line DL may be derived from survey results at the work site. The boundary line DL may be derived from measurement data of the terrain obtained by a measurement by a measurement device mounted on an unmanned aerial vehicle capable of flying over the work site. In a case where the work site is designed using a design method such as computer aided design (CAD), the boundary line DL may be derived from design data of the work site.

The survey line SL is a virtual line that divides between the traveling area AR and the prohibited area ER, derived using the survey vehicle 7. The survey vehicle 7 is a manned vehicle that travels based on the driving of a driver on board. Generally, the outer shape of the survey vehicle 7 is smaller than the outer shape of the transport vehicle 2. The position of the traveling survey vehicle 7 is detected using the global navigation satellite system (GNSS). The survey vehicle 7 is equipped with a position detector 7S that detects the position of the survey vehicle 7 in the global coordinate system. The position detector 7S includes: a GNSS antenna that receives GNSS signals from a GNSS satellite; a GNSS arithmetic unit that calculates the absolute position of the survey vehicle 7 based on the GNSS signal received by the GNSS antenna; and a local coordinate converter that converts the position in the global coordinate system to the position in the local coordinate system. The survey vehicle 7 travels along the boundary line DL of the terrain, such as a bank or a cliff, while detecting the absolute position of the survey vehicle 7 with the position detector 7S. The survey line SL is set based on the traveling locus of the survey vehicle 7.

The outline FL includes an aggregate of a plurality of outline points FP set at intervals. The intervals between the outline points FP may be uniform or non-uniform. The outline FL is defined by the locus passing through the plurality of outline points FP. The position of each of the plurality of outline points FP in the local coordinate system is derived. The position data of the outline FL is defined in the local coordinate system.

In the travel path HL, the outline FL includes an outline FL1 existing on one side and an outline FL2 existing on the other side in the width direction of the travel path HL. The outline FL1 and the outline FL2 face each other in the width direction of the travel path HL. The travel path HL exists between the outline FL1 and the outline FL2.

The two-dimensional course generation unit 12 sets a base line BL in the traveling area AR based on the outline FL of the traveling area AR. The base line BL is a virtual line set for generating the two-dimensional course UC. The position data of the base line BL is defined in the local coordinate system.

The outline data indicating the outline FL is input to the management device 10. As described above, the outline data representing the outline FL is generated based on the boundary line DL or the survey line SL of the work site. When the outline data is generated based on the survey line SL, the outline data is input to the management device 10 by operating a terminal device mounted on the survey vehicle 7. The outline data input to the management device 10 is stored in the storage unit 19. The outline data may be stored in the storage unit 19 by the administrator operating the input device 6. The two-dimensional course generation unit 12 acquires the outline data from the storage unit 19. By operating the input device 6 by the administrator, a departure point and a destination point of the two-dimensional course UC are input as input data. The two-dimensional course generation unit 12 generates the base line BL based on the acquired outline data and input data.

The base line BL is set approximately at the center in the width direction of the travel path HL. The base line BL is set to allow one transport vehicle 2 in one direction and another transport vehicle 2 in its opposite direction to pass each other in traveling on the travel path HL, for example. Note that the base line BL may be set at a portion different from the center in the width direction of the travel path HL. For example, the base line BL may be set at the end in the width direction of the travel path HL. In addition, the base line BL is also set in the work place PA of the traveling area AR.

The base line BL is set in the travel path HL so as to extend along the travel path HL. The base line BL is set so as to connect a starting point and an ending point for the transport vehicle 2 traveling on the travel path HL. The starting point, which is one end of the base line BL, is defined, for example, at an exit of the work place PA, which is a departure point. The ending point, which is the other end of the base line BL, is defined at an entrance of the work place PA, which is a destination point. Note that the one end of the base line BL may be a position where the transport vehicle 2 is stopped.

The base line BL includes an aggregate of a plurality of base points BP set at intervals. The intervals between the base points BP may be uniform or non-uniform. The base line BL is defined by the locus passing through the plurality of base points BP. The position of each of the plurality of base points BP in the local coordinate system is derived.

The two-dimensional course generation unit 12 generates the two-dimensional course UC for the transport vehicle 2 in the traveling area AR based on the base line BL. The two-dimensional course UC is generated in a two-dimensional plane. The position data of the two-dimensional course UC is defined in the local coordinate system. The position of the two-dimensional course UC is defined by the X coordinate and the Y coordinate of the two-dimensional plane. The two-dimensional course UC includes a virtual line indicating a target travel route for the transport vehicle 2 set on the two-dimensional plane. The two-dimensional course UC is set approximately parallel to the base line BL.

The two-dimensional course UC is set on both sides of the base line BL. The two-dimensional course UC includes a two-dimensional course UC1 set on one side of the base line BL and a two-dimensional course UC2 set on the other side of the base line BL. The two-dimensional course UC1 is set between the base line BL and the outline FL1 in the width direction of the travel path HL. The two-dimensional course UC2 is set between the base line BL and the outline FL2 in the width direction of the travel path HL.

The two-dimensional course UC includes a plurality of course points UP set at intervals. The intervals between the course points UP may be uniform or non-uniform. The plurality of course points UP defines the two-dimensional course UC for the transport vehicle 2. The two-dimensional course UC is defined in the two-dimensional plane by the locus passing through the plurality of course points UP. The position of the course point UP is defined by the X coordinate and the Y coordinate of the two-dimensional plane.

The two-dimensional course UC includes travel condition data representing the travel conditions of the transport vehicle 2 that travels in the traveling area AR of the work site. The travel condition data includes at least the target travel route data representing the target travel route of the transport vehicle 2. The travel condition data includes at least one of target position data representing the target position of the transport vehicle 2, target travel speed data representing a target travel speed Vr of the transport vehicle 2, target acceleration data representing the target acceleration of the transport vehicle 2, target deceleration data representing the target deceleration of the transport vehicle 2, target travel direction data representing the target travel direction of the transport vehicle 2, target vehicle stop position data representing the target vehicle stop position regarding the transport vehicle 2, and target vehicle start position data representing the target vehicle start position regarding the transport vehicle.

Each of the plurality of course points UP includes the target position data of the transport vehicle 2 at a position where the course point UP is set, the target travel speed data of the transport vehicle 2 at a position where the course point UP is set, and target travel direction data of the transport vehicle 2 at a position where the course point UP is set. Based on the target travel speed data, the target travel speed Vr of the transport vehicle 2 at the position where the course point UP is set is defined. Based on the target travel direction data, the target travel direction of the transport vehicle 2 at the position where the course point UP is set is defined. Based on the target position data, target travel speed data, and target travel direction data specified for each of the plurality of course points UP, the travel condition including at least one of the travel route, travel speed, acceleration, deceleration, travel direction, vehicle stop position, and vehicle start position of the transport vehicle 2, is defined.

The three-dimensional curved surface generation unit 13 generates a continuous three-dimensional curved surface based on the three-dimensional data acquired by the three-dimensional data acquisition unit 11. The three-dimensional curved surface is a three-dimensional curved surface that indicates the terrain of a work site.

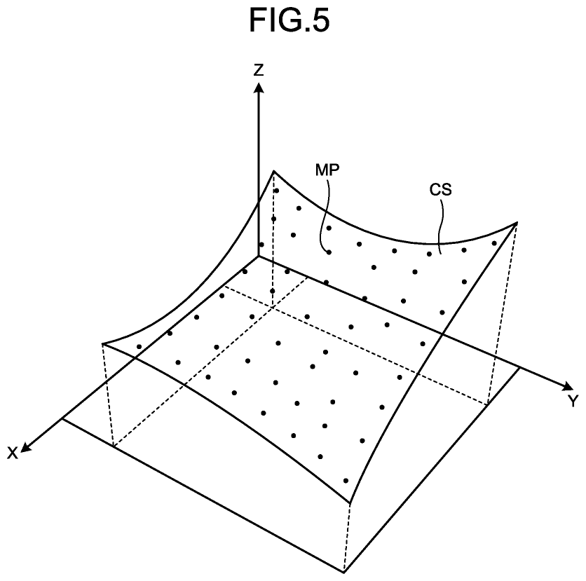

FIG. 5 is a schematic view illustrating the processes performed by the three-dimensional curved surface generation unit 13 according to the embodiment. The three-dimensional data acquired by the three-dimensional data acquisition unit 11 includes the Z coordinate orthogonal to the two-dimensional plane. The three-dimensional data acquired by the three-dimensional data acquisition unit 11 includes point cloud data representing three-dimensional shapes of the terrain of the work site. The point cloud data is an aggregate of a plurality of measurement points MP measured by the three-dimensional measurement device 5 on the surface of the terrain at the work site. The three-dimensional curved surface generation unit 13 interpolates point cloud data containing the plurality of measurement points MP, for example, and generates a three-dimensional curved surface CS formed with a B-spline curved surface. Incidentally, the three-dimensional curved surface generation unit 13 may interpolate the point cloud data containing the plurality of measurement points MP and may generate the three-dimensional curved surface CS formed with an approximate curved surface.

The three-dimensional course generation unit 14 generates the three-dimensional course DC for the transport vehicle 2 from the two-dimensional course UC generated by the two-dimensional course generation unit 12 based on the three-dimensional data of the work site acquired by the three-dimensional data acquisition unit 11. The three-dimensional course generation unit 14 generates the three-dimensional course DC based on the three-dimensional curved surface CS generated by the three-dimensional curved surface generation unit 13. The three-dimensional course DC refers to the target travel route for the transport vehicle 2 set on the surface of the terrain of the work site. The three-dimensional course DC is three-dimensional data of the target travel route.

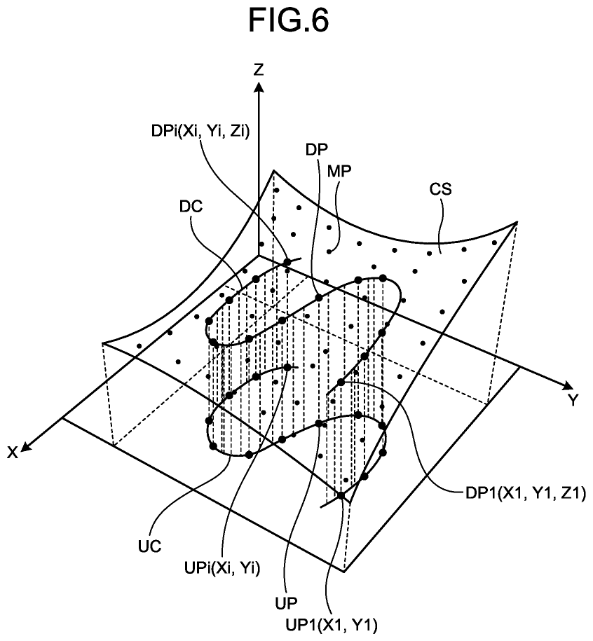

FIG. 6 is a schematic view illustrating the processes performed by the three-dimensional course generation unit 14 according to the embodiment. As illustrated in FIG. 6, an XY plane and an XYZ space are defined at the work site. The position in the XY plane is defined by the X coordinate and the Y coordinate. The position in the XYZ space is defined by the X coordinate, the Y coordinate, and the Z coordinate orthogonal to the XY plane.

The two-dimensional plane in which the two-dimensional course UC is defined is an XY plane including the X-axis and the Y-axis. The two-dimensional course UC is defined by the X coordinate and the Y coordinate on the XY plane. The position, in the XY plane, of each of the plurality of course points UP defining the two-dimensional course UC is defined by the X coordinate and the Y coordinate.

The three-dimensional data acquired by the three-dimensional data acquisition unit 11 and the three-dimensional curved surface CS generated by the three-dimensional curved surface generation unit 13 include the Z coordinate orthogonal to the XY plane. The measurement point MP and the three-dimensional curved surface CS that define the three-dimensional data are defined by the X coordinate, the Y coordinate, and the Z coordinate.

The three-dimensional course generation unit 14 generates the three-dimensional course DC by mapping the two-dimensional course UC to the three-dimensional curved surface CS. The three-dimensional course generation unit 14 adds the Z coordinate of the three-dimensional data to the two-dimensional course UC to generate the three-dimensional course DC. In the embodiment, the three-dimensional course generation unit 14 adds the Z coordinate of the three-dimensional curved surface CS that matches the X coordinate and the Y coordinate of the two-dimensional course UC, to the two-dimensional course UC.

For example, when the X coordinate and Y coordinate of a first course point UP1 are (X1, Y1) among the plurality of course points UP defining the two-dimensional course UC, the three-dimensional course generation unit 14 derives a Z coordinate (Z1) at a point (X1, Y1) on the three-dimensional curved surface CS. The three-dimensional course generation unit 14 determines the coordinates of one course point DP1 among the plurality of course points DP defining the three-dimensional course DC, as coordinates (X1, Y1, Z1). Similarly, when the X coordinate and Y coordinate of a second course point UP2 are (X2, Y2), the three-dimensional course generation unit 14 derives a Z coordinate (Z2) at (X2, Y2) on the three-dimensional curved surface CS, and determines the coordinates of one course point DP2 out of the plurality of course points DP defining the three-dimensional course DC, as (X2, Y2, Z2). When the X and Y coordinates of an i-th course point UPi, among the N course points UP defining the two-dimensional course UC, are (Xi, Yi), the three-dimensional course generation unit 14 derives a Z coordinate (Zi) at (Xi, Yi) on the three-dimensional curved surface CS, and determines the coordinates of the one course point DPi, out of the plurality of course points DP defining the three-dimensional course DC, as (Xi, Yi, Zi).

The three-dimensional course generation unit 14 adds the Z coordinates of the three-dimensional curved surface CS that match the X and Y coordinates of the course point UP of the two-dimensional course UC to the course point UP, making it possible to determine the X, Y, and Z coordinates of each of the plurality of course points DP of the three-dimensional course DC. The three-dimensional course generation unit 14 can generate the three-dimensional course DC by connecting the plurality of course points DP. The three-dimensional course DC includes a three-dimensional curve defined in the XYZ Cartesian coordinate system.

The course judgment unit 15 evaluates the three-dimensional course DC generated by the three-dimensional course generation unit 14. The course judgment unit 15 evaluates the three-dimensional course DC based on specified evaluation items. The evaluation items for the three-dimensional course DC include at least one of the curvature, radius of curvature, or minimum turning radius of the three-dimensional course DC. For the sake of simplicity, the following description assumes that the evaluation item of the three-dimensional course DC is the curvature of the three-dimensional course DC.

The curvature includes the curvature of the three-dimensional course DC centered individually on the X-axis, the Y-axis, and the Z-axis. The course judgment unit 15 compares a predetermined curvature threshold with the curvature of the three-dimensional course DC generated by the three-dimensional course generation unit 14. When the curvature of the three-dimensional course DC is the curvature threshold or more, that is, when the curvature of the three-dimensional course DC is large, the course judgment unit 15 judges that the three-dimensional course DC generated by the three-dimensional course generation unit 14 is inappropriate. When the curvature of the three-dimensional course DC is less than the curvature threshold, that is, when the curvature of the three-dimensional course DC is small, the course judgment unit 15 judges that the three-dimensional course DC generated by the three-dimensional course generation unit 14 is appropriate.

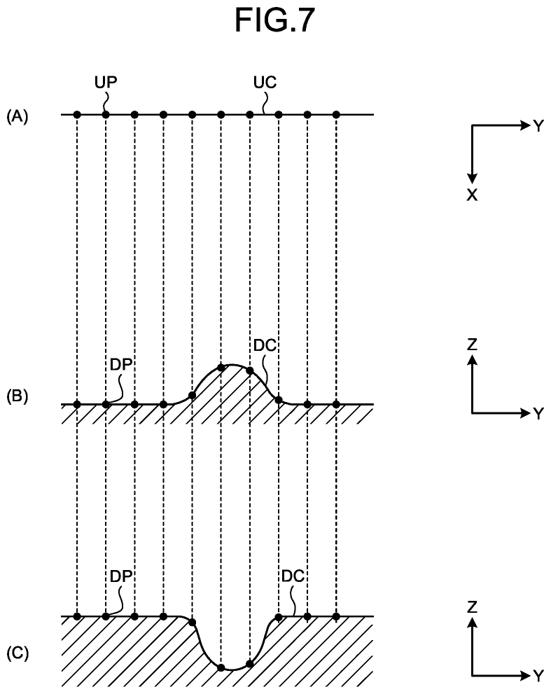

FIG. 7 is a schematic diagram illustrating the processes performed by the course judgment unit 15 according to the embodiment. As illustrated in FIG. 7(A), even when the curvature of the two-dimensional course UC is gentle, the curvature of the three-dimensional course DC centered on the X-axis might increase in the presence of a raised portion at the work site as illustrated in FIG. 7(B), or in the presence of a recessed portion as illustrated in FIG. 7(C). The course judgment unit 15 can determine whether the three-dimensional course DC is appropriate by comparing the curvature of the three-dimensional course DC centered on the X-axis or the Y-axis with the curvature threshold.

The two-dimensional course correction unit 16 outputs correction data for correcting the two-dimensional course UC generated by the two-dimensional course generation unit 12 based on the evaluation by the course judgment unit 15. That is, when the course judgment unit 15 has judged that the three-dimensional course DC is inappropriate, the two-dimensional course correction unit 16 outputs correction data for correcting the two-dimensional course UC.

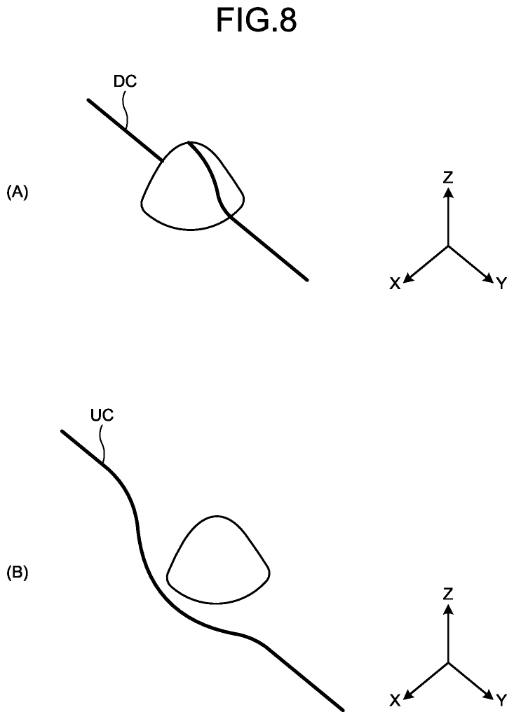

FIG. 8 is a schematic diagram illustrating the processes performed by the two-dimensional course correction unit 16 according to the embodiment. As illustrated in FIG. 8(A), in a case where the curvature of the three-dimensional course DC centered on the X-axis is large due to the raised portion of the travel path HL even though the curvature of the three-dimensional course DC is small on the XY plane, for example, the two-dimensional course correction unit 16 corrects the two-dimensional course UC so that the curvature of the three-dimensional course DC becomes small. Based on the three-dimensional data (three-dimensional curved surface CS) of the work site, the two-dimensional course correction unit 16 searches for a terrain capable of reducing the curvature of the three-dimensional course DC around the portion at which the curvature of the three-dimensional course DC is large. That is, the two-dimensional course correction unit 16 searches for whether a flat portion exists around the raised portion. The two-dimensional course correction unit 16 calculates a difference between adjacent course points DP in the Z-axis direction, for example, and searches for a flat portion that can reduce the difference. With this configuration, as illustrated in FIG. 8(B), the two-dimensional course correction unit 16 can output correction data for correcting the two-dimensional course UC so as to bypass the raised portion.

The three-dimensional course generation unit 14 corrects the two-dimensional course UC based on the correction data output from the two-dimensional course correction unit 16 and re-generates the three-dimensional course DC.

The travel speed determination unit 17 determines the target travel speed Vr of the transport vehicle 2 based on the three-dimensional course DC generated by the three-dimensional course generation unit 14. The travel speed determination unit 17 determines the target travel speed Vr of the transport vehicle 2 based on the three-dimensional course DC generated by the three-dimensional course generation unit 14 and the traveling performance of the transport vehicle 2 stored in the storage unit 19. The traveling performance of the transport vehicle 2 is known data that can be derived from design data or specification data of the transport vehicle 2, and is stored in advance in the storage unit 19. The traveling performance of the transport vehicle 2 may be derived by a preliminary experiment or a simulation and may be stored in advance in the storage unit 19.

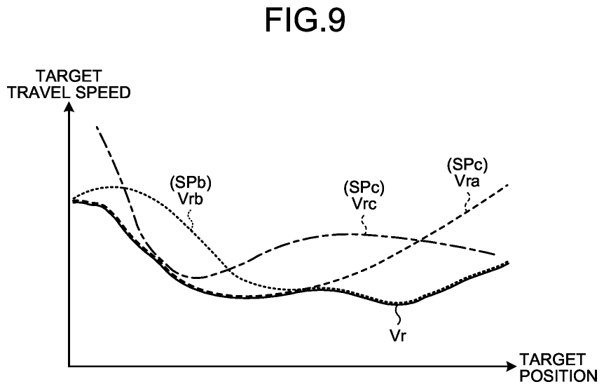

FIG. 9 is a schematic diagram illustrating the processes performed by the travel speed determination unit 17 according to the embodiment. The travel speed determination unit 17 derives the maximum value of the target travel speed Vr at which the transport vehicle 2 can travel for each of the plurality of performance items of the traveling performance of the transport vehicle 2. In a graph illustrated in FIG. 9, the horizontal axis indicates the position of the three-dimensional course DC, and the vertical axis indicates the maximum value of the target travel speed Vr at which the transport vehicle 2 can travel according to the position of the three-dimensional course DC.

As illustrated in FIG. 9, the travel speed determination unit 17 calculates a maximum value of a target travel speed Vra at individual positions of the three-dimensional course DC based on a first performance item SPa. The travel speed determination unit 17 calculates a maximum value of a target travel speed Vrb at individual positions of the three-dimensional course DC based on a second performance item SPb. The travel speed determination unit 17 calculates a maximum value of a target travel speed Vrc at individual positions of the three-dimensional course DC based on a third performance item SPc.

Examples of performance items include at least one of the maximum output of the driving device 31, the braking capability of the braking device 32, the slip limit of the tire 24, or the grip of the tire 24. When the first performance item is the maximum output of the driving device 31, for example, the travel speed determination unit 17 calculates a maximum output ra which is highest within a range that the transport vehicle 2 can hold without deviating from the three-dimensional course DC and within a range that the transport vehicle 2 can hold without causing roll-over, based on the maximum output of the driving device 31. When the second performance item is the braking capability of the braking device 32, for example, the travel speed determination unit 17 calculates a braking capability rb which is highest within a range that the transport vehicle 2 can hold without deviating from the three-dimensional course DC, based on the braking capability of the braking device 32. When the third performance item is the slip limit of the tire 24, for example, the travel speed determination unit 17 calculates a slip limit rc which is highest within a range that the transport vehicle 2 can hold without deviating from the three-dimensional course DC, based on the slip limit of the tire 24.

The travel speed determination unit 17 determines the maximum output ra, the braking capability rb, and the slip limit rc to low values in the portion of the three-dimensional course DC having a large curvature. In the portion of the three-dimensional course DC where the curvature is small, the maximum output ra, braking capability rb, and slip limit rc are determined to be high values.

The three-dimensional course DC is defined by the plurality of course points DP. In the embodiment, each of the course points DP includes terrain inclination data in addition to the X coordinate, the Y coordinate, and the Z coordinate. The terrain inclination data includes a pitch angle indicating an inclination angle of the transport vehicle 2 in the front-rear direction and a roll angle indicating an inclination angle of the transport vehicle 2 in the vehicle width direction. The travel speed determination unit 17 calculates the maximum output ra, the braking capability rb, and the slip limit rc based on the roll angle.

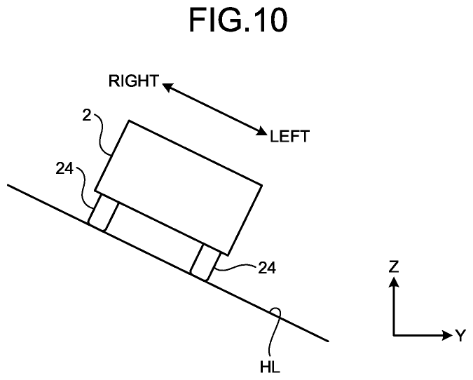

FIG. 10 is a schematic view illustrating the processes performed by the travel speed determination unit 17 according to the embodiment. As illustrated in FIG. 10, for example, in a case where the transport vehicle 2 travels to turn left on the travel path HL in which a roll angle is applied to the transport vehicle 2 so that the left portion of the transport vehicle 2 is located below the right portion, the transport vehicle 2 can stably travel on the travel path HL even with increased levels of the maximum output ra, the braking capability rb, and the slip limit rc of the transport vehicle 2. In contrast, for example, in a case where the transport vehicle 2 travels to turn left on the travel path HL in which the roll angle is applied to the transport vehicle 2 so that the right portion of the transport vehicle 2 is located below the left portion, the transport vehicle 2 cannot stably travel on the travel path HL with an increased level of the target travel speed Vr (including Vra, Vrb, and Vrc) for the transport vehicle 2. By determining the maximum value of the target travel speed Vr (Vra, Vrb, and Vrc) based on the roll angle defined for each of the plurality of course points DP, the travel speed determination unit 17 can calculate the highest target travel speed Vrb within a range that the transport vehicle 2 can hold without deviating from the three-dimensional course DC.

As illustrated in FIG. 9, at each of the plurality of positions of the three-dimensional course DC, the travel speed determination unit 17 determines the lowest value among the target travel speed Vra, the target travel speed Vrb, and the target travel speed Vrc, as the target travel speed Vr at the position of the three-dimensional course DC.

The output unit 18 outputs the three-dimensional course DC generated by the three-dimensional course generation unit 14 to the travel control device 40 of the transport vehicle 2. The output unit 18 outputs the three-dimensional course DC to the travel control device 40 in a state where the target travel speed Vr at each of positions of the three-dimensional course DC determined by the travel speed determination unit 17 is applied to the course point DP of the three-dimensional course DC. The course point DP output to the travel control device 40 includes individual pieces of data of the X coordinate, the Y coordinate, the Z coordinate, the inclination data (roll angle and pitch angle), and the target travel speed Vr.

The three-dimensional course DC generated by the three-dimensional course generation unit 14 may be stored in the storage unit 19. The output unit 18 may output the three-dimensional course DC stored in the storage unit 19 to the travel control device 40.

[Travel Control Device]

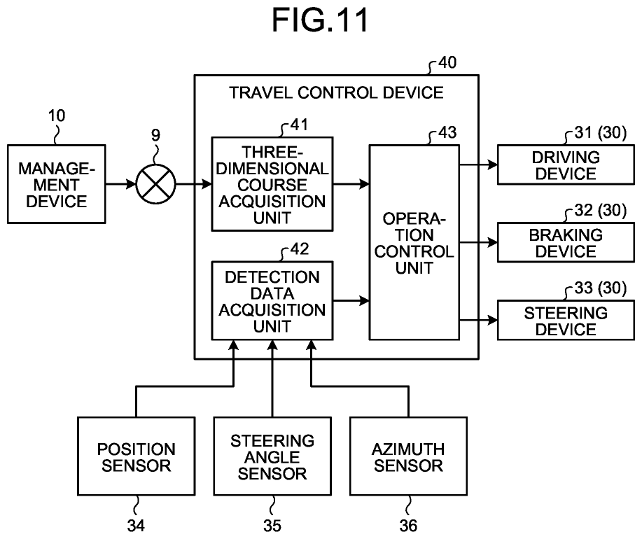

FIG. 11 is a functional block diagram illustrating an example of the travel control device 40 according to the embodiment. The travel control device 40 is connected to the traveling device 30. The traveling device 30 includes the driving device 31, the braking device 32, and the steering device 33. Furthermore, the travel control device 40 is connected to a position sensor 34, a steering angle sensor 35, and an azimuth sensor 36. The driving device 31, the braking device 32, the steering device 33, the position sensor 34, the steering angle sensor 35, and the azimuth sensor 36 are mounted on the transport vehicle 2.

The driving device 31 operates to drive the traveling device 30 of the transport vehicle 2. The driving device 31 generates a driving force for driving the traveling device 30. The driving device 31 generates a driving force for rotating the rear wheels 25R. The driving device 31 includes an internal combustion engine such as a diesel engine, for example. The driving device 31 may include: a generator that generates electric power by operating an internal combustion engine; and an electric motor that operates based on the electric power generated by the generator.

The braking device 32 operates to brake the traveling device 30. The braking device 32 operates to decelerate or stop the traveling of the traveling device 30.

The steering device 33 operates to steer the traveling device 30. The transport vehicle 2 is steered by the steering device 33. The steering device 33 steers the front wheels 25F.

The position sensor 34 detects the absolute position of the transport vehicle 2. The position sensor 34 includes: a GNSS antenna that receives GNSS signals from a GNSS satellite; a GNSS arithmetic unit that calculates the absolute position of the transport vehicle 2 based on the GNSS signal received by the GNSS antenna; and a local coordinate converter that converts the position in the global coordinate system to the position in the local coordinate system.

The steering angle sensor 35 detects the steering angle of the transport vehicle 2 by the steering device 33. The azimuth sensor 36 detects the azimuth of the transport vehicle 2. The steering angle sensor 35 includes a rotary encoder provided in the steering device 33, for example. The azimuth sensor 36 includes a gyro sensor provided on the vehicle body frame 21, for example.

The travel control device 40 includes a three-dimensional course acquisition unit 41, a detection data acquisition unit 42, and an operation control unit 43.

The three-dimensional course acquisition unit 41 acquires the three-dimensional course DC generated by the management device 10.

The detection data acquisition unit 42 acquires position data indicating the position of the transport vehicle 2 from the position sensor 34. The detection data acquisition unit 42 acquires steering angle data indicating the steering angle of the steering device 33 from the steering angle sensor 35. The detection data acquisition unit 42 acquires the azimuth data indicating the azimuth of the transport vehicle 2 from the azimuth sensor 36.

The operation control unit 43 outputs a control command to control at least one of the driving device 31, the braking device 32, and the steering device 33 of the transport vehicle 2 based on the three-dimensional course DC acquired by the three-dimensional course acquisition unit 41. The control command generated by the operation control unit 43 is output from the operation control unit 43 to the traveling device 30. The control command output from the operation control unit 43 includes an accelerator command output to the driving device 31, a braking command output to the braking device 32, and a steering command output to the steering device 33. Based on the position data detected by the position sensor 34, the operation control unit 43 controls the driving device 31, the braking device 32, and the steering device 33 so that the transport vehicle 2 can travel in a state of following the traveling course CS.

[Management Method]

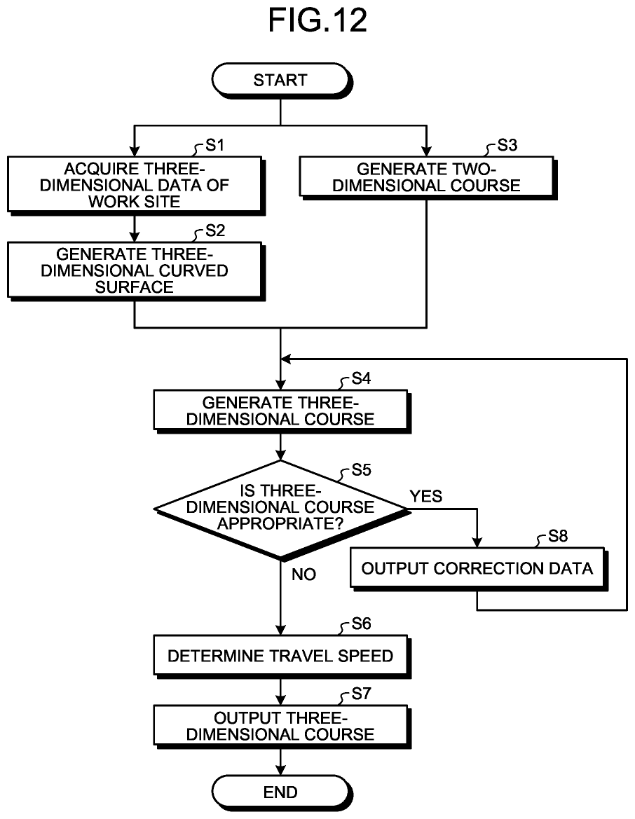

FIG. 12 is a flowchart illustrating an example of a management method for the transport vehicle 2 according to the embodiment. The three-dimensional measurement device 5 acquires three-dimensional data of the work site. The three-dimensional measurement device 5 transmits the three-dimensional data to the management device 10. The three-dimensional data acquisition unit 11 acquires the three-dimensional data from the three-dimensional measurement device 5 (step S1).

The three-dimensional data includes point cloud data having a plurality of measurement points MP. The three-dimensional curved surface generation unit 13 generates the continuous three-dimensional curved surface CS from the three-dimensional data (step S2).

The two-dimensional course generation unit 12 generates the two-dimensional course UC on an XY plane set at the work site (step S3).

The two-dimensional course generation unit 12 acquires outline data indicating the outline FL of the traveling area AR, acquires position data of the entrance of the work place PA to be the departure point and position data of the exit of the work place PA to be the destination point, individually, calculates starting point data and ending point data of the base line BL, and generates the base line BL based on the outline FL. Furthermore, the two-dimensional course generation unit 12 generates the two-dimensional course UC based on the base line BL.

The three-dimensional course generation unit 14 generates the three-dimensional course DC based on the three-dimensional curved surface CS generated in step S2 and the two-dimensional course UC generated in step S3 (step S4).

The three-dimensional course generation unit 14 adds the Z coordinate of the three-dimensional curved surface CS that matches the X and Y coordinates of the course point UP defining the two-dimensional course UC, to the course point UP of the two-dimensional course UC, thereby generating the course point DP of the three-dimensional course DC. The three-dimensional course generation unit 14 connects the plurality of generated course points DP thereby generating the three-dimensional course DC which is continuous.

The course judgment unit 15 judges whether the three-dimensional course DC generated in step S5 is appropriate (step S5).

The course judgment unit 15 compares a predetermined curvature threshold with the curvature of the three-dimensional course DC. When the curvature of the three-dimensional course DC is the curvature threshold or more, the course judgment unit 15 judges that the three-dimensional course DC is inappropriate. When the curvature of the three-dimensional course DC is less than the curvature threshold, the determination is that the three-dimensional course DC is appropriate.

When it is determined in step S5 that the three-dimensional course DC is appropriate (step S5: No), the travel speed determination unit 17 determines the target travel speed Vr of the transport vehicle 3 based on the three-dimensional course DC (step S6).

The travel speed determination unit 17 determines the target travel speed Vr of the transport vehicle 2 based on the three-dimensional course DC and the traveling performance of the transport vehicle 2 stored in the storage unit 19. The three-dimensional course DC includes the curvature and the roll angle at the course point DP.

The output unit 18 outputs the three-dimensional course DC to the travel control device 40 in a state where the target travel speed Vr at each of positions of the three-dimensional course DC determined in step S6 is applied to the course point DP of the three-dimensional course DC (step S7).

The travel control device 40 of the transport vehicle 2 travels in the work site following the three-dimensional course DC transmitted from the management device 10.

When it is determined in step S5 that the three-dimensional course DC is inappropriate (step S5: Yes), the two-dimensional course correction unit 16 outputs the correction data for correcting the two-dimensional course UC to the two-dimensional course generation unit 12 (step S8).

As described with reference to FIG. 8, when the curvature of at least a part of the three-dimensional course DC has been determined to be the curvature threshold or more, the two-dimensional course correction unit 16 outputs the correction data for correcting the two-dimensional course UC so as to reduce the curvature of the three-dimensional course DC. Based on the three-dimensional data (three-dimensional curved surface CS), the two-dimensional course correction unit 16 searches for a terrain capable of reducing the curvature of the three-dimensional course DC around the portion at which the curvature of the three-dimensional course DC is large. The two-dimensional course correction unit 16 outputs correction data for correcting the two-dimensional course UC so as to bypass a raised portion, for example. That is, since the two-dimensional course correction unit 16 can relax the curvature by moving a control point, it is possible to output the correction data by utilizing this characteristic.

The three-dimensional course generation unit 14 corrects the two-dimensional course UC based on the correction data output from the two-dimensional course correction unit 16 and re-generates the three-dimensional course DC (step S4).

[Effects]

As described above, according to the embodiment, after the two-dimensional course UC is generated, the three-dimensional course DC is generated from the two-dimensional course UC based on the three-dimensional data of the work site. This generates the three-dimensional course DC that takes the terrain of the work site in consideration. By generating the three-dimensional course DC in consideration of the terrain of the work site, the transport vehicle 2 can be driven to travel at an appropriate travel speed V according to the three-dimensional course DC. Allowing the transport vehicle 2 to travel at the appropriate travel speed V would make it possible to suppress the deterioration in productivity at the work site.

In addition, the two-dimensional course UC and the three-dimensional course DC can be converted to each other. Therefore, when it is desired to correct the three-dimensional course DC, for example, it is only required to correct or alter the two-dimensional course UC as usual, making it possible to execute the process of correction or alteration without spending much time and money.

By generating the three-dimensional curved surface CS of the work site from the three-dimensional data including the point cloud data, it is possible to generate the three-dimensional course DC suitable for the terrain of the work site.

The two-dimensional course UC is defined by the X coordinate and Y coordinate. The three-dimensional data includes the Z coordinate. With this configuration, by adding the Z coordinate of the three-dimensional data to the two-dimensional course UC, it is possible to generate the three-dimensional course DC defined by the X coordinate, the Y coordinate, and the Z coordinate.

Each of the plurality of course points DP of the three-dimensional course DC includes inclination data including roll angle and pitch angle, in addition to the X coordinate, Y coordinate, and Z coordinate. By including the inclination data, the transport vehicle 2 can be driven at an appropriate travel speed. As described with reference to FIG. 10, even if there is a roll angle, the travel speed can be increased depending on the turning direction. This makes it possible to suppress deterioration in the productivity at the work site.

In addition, the target travel speed of the transport vehicle 2 can be set in consideration of the performance or posture of the transport vehicle 2.

In the above-described embodiment, the three-dimensional curved surface generation unit 13 generates the three-dimensional curved surface CS from the three-dimensional data as a three-dimensional model. The three-dimensional curved surface generation unit 13 may also generate, from the three-dimensional data, a three-dimensional mesh model such as a triangular mesh model, as a three-dimensional model. The three-dimensional curved surface generation unit 13 may also generate a three-dimensional course CS based on the three-dimensional mesh model.

### Other Embodiments

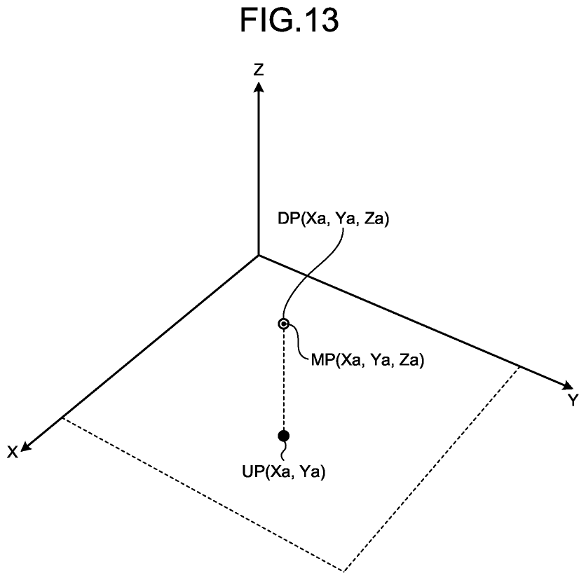

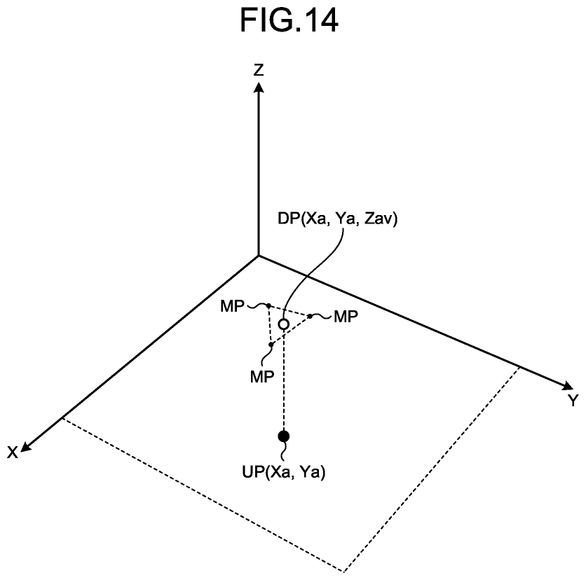

FIGS. 13 and 14 are schematic views illustrating the processes performed by the three-dimensional course generation unit 14 according to an embodiment. In the above-described embodiment, the three-dimensional curved surface CS is generated from the three-dimensional data, and then, the three-dimensional course generation unit 14 generates the three-dimensional course DC based on the three-dimensional curved surface CS. The three-dimensional curved surface CS does not have to be generated.

As illustrated in FIG. 13, when there is a match between the X and Y coordinates (Xa, Ya) of the course point UP of the two-dimensional course UC and the X and Y coordinates (Xa, Ya) of at least one measurement point MP among the plurality of measurement points MP, the three-dimensional course generation unit 14 can generate the course point DP of the three-dimensional course DC by adding the Z coordinate (Za) of the measurement point MP that matches the X and Y coordinates of the course point UP of the two-dimensional course UC, to the course point UP of the two-dimensional course UC.

Incidentally, as illustrated in FIG. 14, there is a case where the X coordinate and Y coordinate (Xa, Ya) of the course point UP of the two-dimensional course UC does not match the X coordinate and Y coordinate of the plurality of measurement points MP. In that case, at least three measurement points MP existing around (Xa, Ya) in the XY plane may be selected, and an average value (Zav) of the Z coordinates of those three measurement points MP may be added to the course point UP of the two-dimensional course UC.

In the above embodiment, the two-dimensional course UC is defined by the course point UP. The two-dimensional course UC may be defined by a function or mathematical formula.

[Computer System]

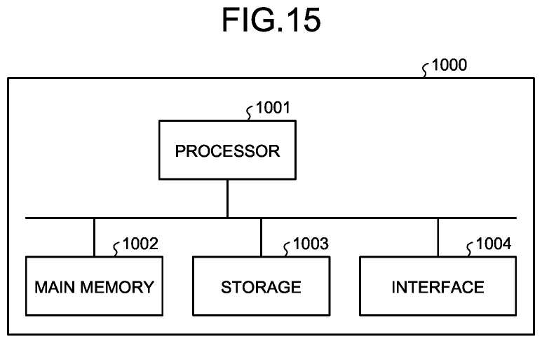

FIG. 15 is a block diagram illustrating an example of a computer system 1000 according to an embodiment. The management device 10 and the travel control device 40 described above each include the computer system 1000. The computer system 1000 includes: a processor 1001 including a processor such as a central processing unit (CPU); main memory 1002 including non-volatile memory such as read only memory (ROM) and volatile memory such as random access memory (RAM); storage 1003; and an interface 1004 including an input/output circuit. The function of the management device 10 and the function of the travel control device 40 described above are stored as a program in the storage 1003. The processor 1001 reads the program from the storage 1003, expands the program to the main memory 1002, and executes the above-described processes according to the program. The program may be delivered to the computer system 1000 via a network.

The computer system 1000 executes processes of: acquiring three-dimensional data of the work site; generating the three-dimensional course DC from the two-dimensional course UC of the transport vehicle 2 defined in the work site, based on the three-dimensional data; and outputting the generated three-dimensional course DC to the travel control device 40 of the transport vehicle 2, according to the above-described embodiment.

In the above-described embodiment, the position data of the base line BL is defined in the local coordinate system. The position data of the base line BL may be defined in the global coordinate system.

The travel control device 40 may include a part or all of the functions of the management device 10. For example, the travel control device 40 may include part or all of the functions of the three-dimensional data acquisition unit 11, the two-dimensional course generation unit 12, the three-dimensional curved surface generation unit 13, the three-dimensional course generation unit 14, the course judgment unit 15, the two-dimensional course correction unit 16, and the travel speed determination unit 17. In a configuration in which the travel control device 40 has all the functions of the management device 10, the communication system 9 may be omitted.

### REFERENCE SIGNS LIST

1 MANAGEMENT SYSTEM
2 TRANSPORT VEHICLE
3 LOADING MACHINE
4 CRUSHER
5 THREE-DIMENSIONAL MEASUREMENT DEVICE
6 INPUT DEVICE
7 SURVEY VEHICLE
7S POSITION DETECTOR
8 ADMINISTRATION FACILITY
9 COMMUNICATION SYSTEM
10 MANAGEMENT DEVICE
11 THREE-DIMENSIONAL DATA ACQUISITION UNIT
12 TWO-DIMENSIONAL COURSE GENERATION UNIT
13 THREE-DIMENSIONAL CURVED SURFACE GENERATION UNIT
14 THREE-DIMENSIONAL COURSE GENERATION UNIT
15 COURSE JUDGMENT UNIT
16 TWO-DIMENSIONAL COURSE CORRECTION UNIT
17 TRAVEL SPEED DETERMINATION UNIT
18 OUTPUT UNIT
19 STORAGE UNIT
21 VEHICLE BODY FRAME
22 DUMP BODY
24 TIRE
25 WHEEL
25F FRONT WHEEL
25R REAR WHEEL
26 REAR AXLE
30 TRAVELING DEVICE
31 DRIVING DEVICE
32 BRAKING DEVICE
33 STEERING DEVICE
34 POSITION SENSOR
35 STEERING ANGLE SENSOR
36 AZIMUTH SENSOR
40 TRAVEL CONTROL DEVICE
41 THREE-DIMENSIONAL COURSE ACQUISITION UNIT
42 DETECTION DATA ACQUISITION UNIT
43 OPERATION CONTROL UNIT
1000 COMPUTER SYSTEM
1001 PROCESSOR
1002 MAIN MEMORY
1003 STORAGE
1004 INTERFACE
AR TRAVELING AREA
AX ROTATION AXIS
BL BASE LINE
BP BASE POINT
CS THREE-DIMENSIONAL CURVED SURFACE
DC THREE-DIMENSIONAL COURSE
DL BOUNDARY LINE
DPA DUMPING AREA
ER PROHIBITED AREA
FL OUTLINE
FL1 OUTLINE
FL2 OUTLINE
FP OUTLINE POINT
HL TRAVEL PATH
IS INTERSECTION
LPA LOADING AREA
MP MEASUREMENT POINT
PA WORK PLACE
SL SURVEY LINE
UC TWO-DIMENSIONAL COURSE
UC1 TWO-DIMENSIONAL COURSE
UC2 TWO-DIMENSIONAL COURSE
UP COURSE POINT

1. A transport vehicle management system comprising:
a three-dimensional data acquisition unit that acquires three-dimensional data of a work site;
a two-dimensional course generation unit that generates a two-dimensional course for a transport vehicle on a two-dimensional plane set at the work site; and
a three-dimensional course generation unit that generates a three-dimensional course of the transport vehicle from the two-dimensional course, based on the three-dimensional data.

2. The transport vehicle management system according to claim 1,
wherein the three-dimensional data includes point cloud data,
the transport vehicle management system further comprises a three-dimensional curved surface generation unit that generates a three-dimensional model from the three-dimensional data, and
the three-dimensional course generation unit generates the three-dimensional course based on the three-dimensional model.

3. The transport vehicle management system according to claim 1,
wherein the two-dimensional course is defined by a first coordinate and a second coordinate on the two-dimensional plane,
the three-dimensional data includes a third coordinate orthogonal to the two-dimensional plane, and
the three-dimensional course generation unit adds the third coordinate of the three-dimensional data to the two-dimensional course and generates the three-dimensional course.

4. The transport vehicle management system according to claim 1,
wherein the two-dimensional course is defined by a first coordinate and a second coordinate on the two-dimensional plane,
the three-dimensional data includes point cloud data,
the point cloud data includes a third coordinate orthogonal to the two-dimensional plane,
the transport vehicle management system further comprises a three-dimensional curved surface generation unit that generates a three-dimensional curved surface from the three-dimensional data, and
the three-dimensional course generation unit adds the third coordinate of the three-dimensional curved surface that matches the first coordinate and the second coordinate of the two-dimensional course, to the two-dimensional course.

5. The transport vehicle management system according to claim 3,
wherein the three-dimensional course includes a three-dimensional curve.

6. The transport vehicle management system according to claim 3,
wherein the three-dimensional course is defined by a plurality of course points, and
each of the course points includes the first coordinate, the second coordinate, the third coordinate, and inclination data.

7. The transport vehicle management system according to claim 1, further comprising
a course judgment unit that evaluates the three-dimensional course.

8. The transport vehicle management system according to claim 7, further comprising
a two-dimensional course correction unit that outputs correction data for correcting the two-dimensional course based on an evaluation by the course judgment unit,
wherein the three-dimensional course generation unit corrects the two-dimensional course based on the correction data and re-generates the three-dimensional course.

9. The transport vehicle management system according to claim 1, further comprising
a travel speed determination unit that determines a target travel speed of the transport vehicle based on the three-dimensional course.

10. The transport vehicle management system according to claim 1, further comprising
an output unit that outputs the three-dimensional course to a travel control device of the transport vehicle.

11. A transport vehicle management method comprising:
acquiring three-dimensional data of a work site;
generating a three-dimensional course from a two-dimensional course of a transport vehicle defined in the work site, based on the three-dimensional data; and
outputting the generated three-dimensional course to a travel control device of the transport vehicle.

12. The transport vehicle management system according to claim 4,
wherein the three-dimensional course includes a three-dimensional curve.

13. The transport vehicle management system according to claim 4,
wherein the three-dimensional course is defined by a plurality of course points, and
each of the course points includes the first coordinate, the second coordinate, the third coordinate, and inclination data.
